(19) United States
(12) Patent Application Publication
(10) Pub. No.: US 2003/0077469 A1
(43) Pub. Date: Apr. 24, 2003

(54) Use of anti-oxidants in clear powder coatings to reduce filiform corrosion over aluminum

(76) Inventors: Anthony M. Chasser, Allison Park, PA (US); John R. Schneider, Glenshaw, PA (US)

Correspondence Address: PPG INDUSTRIES, INC., Intellectual Property Department, One PPG Place, Pittsburgh, PA, 15272, US

(21) Appl. No.: 10/047,527

(22) Filed: Oct. 23, 2001

(51) Int. Cl. B32B 27/00

(52) U.S. Cl. 428/500

(57) ABSTRACT

A curable powder coating composition is disclosed which comprises a polymer containing reactive functional groups, a curing agent having functional groups that are reactive with the functional groups of said polymer which is present in an amount sufficient to cure said polymer, and a phenolic compound having substituted groups on the two groups adjacent to the hydroxy group on the aromatic ring. The curable powder coating composition exhibits improved filiform corrosion resistance properties.

### FIELD OF THE INVENTION

The invention relates to powder clear coat compositions, especially powder clear coat compositions that demonstrate improved filiform resistance properties when applied over aluminum substrates.

### BACKGROUND

Solid particulate coating formulations referred to in the industry as “powder coatings” can be applied over various substrates. Little, if any, volatile material is given off to the surrounding environment when powder coating compositions are cured. Due to stricter limitations on volatile organic content (VOC), powder coating compositions are extremely popular.

Unfortunately, powder coating compositions are very susceptible to filiform corrosion, especially when they are applied over aluminum substrates. Filiform corrosion generally appears as a filamentous, worm-like defect under the coating layer. Because filiform corrosion adversely affects appearance and can cause coating layers to peel away from the substrate, it is very a serious problem. The present invention is a powder composition which exhibits superior filiform corrosion resistance properties; especially when it is applied over aluminum.

### SUMMARY OF THE INVENTION

The present invention is a curable powder coating composition comprising a polymer containing reactive functional groups, a curing agent having functional groups reactive with the functional groups of the polymer which is present in an amount sufficient to cure the polymer, and a phenolic compound having substituted groups on the two groups adjacent to the hydroxy group on the aromatic ring.

### DETAILED DESCRIPTION OF THE INVENTION

Various numerical ranges are disclosed in this patent application. Because these ranges are continuous, they include every value between the minimum and maximum values. Unless expressly indicated otherwise, the various numerical ranges specified in this application are approximations. It is implied that the minimum and maximum values within the stated ranges are preceded by the word “about”. Therefore, slight variations above and below the stated ranges can be used to achieve substantially the same results.

The powder coating composition of the present invention comprises a polymer having reactive functional groups. The polymer having reactive functional groups can be chosen from a variety of materials, including but not limited to, acrylic polymers, polyurethane polymers, and polyester polymers. The polymer will contain functional groups selected from carboxylic acid, epoxy, hydroxyl, amino, carbamate and urea.

In an embodiment of the invention, the polymer having reactive functional groups is an acrylic polymer. The acrylic polymer containing the appropriate functional groups can be formed by reacting polymerizable alpha, beta-ethylenically unsaturated monomers containing the functional groups mentioned above with one or more other polymerizable, unsaturated monomers.

Suitable carboxylic acid group-containing monomers include acrylic acid, methacrylic acid, crotonic acid, itaconic acid, fumaric acid, maleic acid, citraconic acid, and monoalkylesters of unsaturated dicarboxyiic acids. Acrylic acid and methacrylic acid are the preferred carboxylic acids. Suitable epoxy group-containing monomers include glycidyl acrylate and glycidyl methacrylate. Suitable amino group-containing monomers include aminoethyl methacrylate and aminopropyl methacrylic.

Pendant carbamate functional groups can be incorporated into the acrylic polymer by copolymerizing the acrylic monomers with a carbamate functional vinyl monomer. Examples of suitable carbamate functional monomers include carbamate functional alkyl esters of methacrylic acid; the reaction product of hydroxyethyl methacrylate, isophorone diisocyanate, and hydroxypropyl carbamate; the reaction product of hydroxypropyl methacrylate, isophorone diisocyanate, and methanol; and the reaction product of isocyanic acid with a hydroxyl functional acrylic or methacrylic monomer like hydroxyethyl acrylate.

Pendant urea groups can be incorporated into the acrylic polymer by copolymerizing the acrylic monomers with urea functional vinyl monomers. Examples of urea functional monomers include urea functional alkyl esters of acrylic acid or methacrylic acid and the reaction product of hydroxyethyl methacrylate, isophorone diisocyanate, and hydroxyethyl ethylene urea.

The acrylic polymers typically have number average molecular weights of about 1,000 to 10,000 or 3,000 to 5,000 based on gel permeation chromatography using a polystyrene standard. The acrylic polymers will have equivalent weights (based on the functional groups mentioned above) from 200 to 2,500 gram/equivalent or from 1,400 to 1,900 gram/equivalent. The glass transition temperature (T(g)) of the polymer is typically about 30° C. to 75° C. or 35° C. to 55° C. The T(g) is determined by Differential Scanning Calorimetry (DSC) usually at a rate of heating of 18° F. (10° C.) per minute.

In another embodiment of the present invention, the polymer having reactive functional groups is a polyurethane polymer containing the functional groups mentioned above for the acrylic polymers. These polymers can be prepared by reacting polyols and polyisocyanates to form a polyurethane. Examples of suitable polyols include low molecular weight aliphatic polyols such as ethylene glycol, propylene glycol, butylene glycol, 1,6-hexylene glycol, neopentyl glycol, cyclohexanedimethanol, trimethylolpropane and the like. High molecular weight polymeric polyols such as polyether polyols and polyester polyols are usually used with the lower molecular weight polyols. Examples of polyether polyols are those formed from the oxyalkylation of various polyols like glycols or higher polyols. Suitable glycols include ethylene glycol, 1,6-hexanediol, Bisphenol A. Suitable higher polyols include trimethylol propane and pentaerythritol.

Exemplary polyester polyols can be prepared by the polyesterification of organic polycarboxylic acids or anhydrides thereof with organic polyols. Usually, the polycarboxylic acids and polyols are aliphatic or aromatic dibasic acids and diols.

Examples of suitable polyisocyanates include aromatic and aliphatic polyisocyanates with the aliphatic polyisocyanates being preferred for exterior durability. Specific examples include 1,6-hexamethylene diisocyanate, isophorone diisocyanate and 4,4′-methylene-bis-(cyclohexyl isocyanate).

To introduce carboxylic acid functionality into the polyurethane, react the polyurethane polyol with polycarboxylic acids such as succinic acid, adipic acid, azelaic acid, sebacic acid, terephthalic acid, isophthalic acid, tetrahydrophthalic acid, hexahydrophthalic acid, trimellitic acid and anhydrides of such acids. Alternatively, the polyisocyanate can be reacted with a mixture of the polyols mentioned above and a polyol containing carboxylic acid groups such as dimethylol propionic acid.

To introduce hydroxyl functionality into the polyurethane, react the polyisocyanate with a stoichiometric excess of the polyol component to form a polyurethane polyol.

To introduce epoxy functionality into the polyurethane, include a hydroxy functional epoxy compound like glycidol with the polyol component. To incorporate amino functionality into the polyurethane, include a polyamine in the monomer charge. Suitable amines include primary and secondary diamines and polyamines in which the radicals attached to the nitrogen atoms are saturated, aliphatic, alicyclic, aromatic, aromatic-substituted aliphatic, aliphatic-substituted aromatic, or heterocyclic.

To incorporate pendant carbamate groups into the polyurethane, form a hydroxyalkyl carbamate which can be reacted with polyacids or polyols used to form the polyurethane. To introduce pendant urea groups into the polyurethane, react a hydroxyl functional urea such as hydroxyalkyl ethylene urea with polyacids and polyols used to form the polyurethane. Also, isocyanate terminated polyurethane can be reacted with primary amines, aminoalkyl ethylene urea, or hydroxyalkyl ethylene urea to yield a material with pendant urea groups.

The polyurethane polymers typically have number average molecular weights of about 3,000 to 25,000 or 5,000 to 10,000 based on gel permeation chromatography using a polystyrene standard. The polyurethane polymers will have hydroxyl equivalent weights (based on the functional groups mentioned above) from 200 to 2,500 gram/equivalent or from 1,400 to 1,900 gram/equivalent. The T(g) of the polymer is typically about 35° C. to 85° C. or 45° C. to 60° C.

In another embodiment of the invention, the polymer having reactive groups is a polyester polymer having the functional groups mentioned above. These polymers are based on a condensation reaction of low molecular weight aliphatic polyols, including cycloaliphatic polyols, with aliphatic and/or aromatic polycarboxylic acids and anhydrides. Examples of suitable aliphatic polyols include 1,2-ethanediol, 1,3-propanediol, 1,4-butanediol, 1,6-hexanediol, neopentyl glycol, cyclohexane dimethanol, trimethylol propane, and the like. Polymeric polyols such as the polyether polyols mentioned above can also be used in combination with the low molecular weight polyols. Examples of suitable polycarboxylic acids and anhydrides include succinic acid, adipic acid, azelaic acid, sebacic acid, terephthalic acid, isophthalic acid, tetrahydrophthalic acid, hexahydrophthalic acid, trimellitic acid and anhydrides of such acids.

To introduce carboxylic acid functionality into the polyester, react a stoichiometric excess of the polycarboxylic acid with the polyol. To introduce hydroxyl functionality into the polyester, react a stoichiometric excess of the polyol component with the polycarboxylic acid.

To introduce epoxy groups into the polyester, include an epoxy functional compound such as glycidol with the polyol component. To introduce amino groups into the polyester, include an amino alcohol such as amino ethanol or amino propanol with the polyol component.

To incorporate pendant carbamate groups into the polyester, form a hydroxyalkyl carbamate which can be reacted with polyacids or polyols used to form the polyester. To introduce pendant urea groups into the polyurethane, react a hydroxyl functional urea such as hydroxyalkyl ethylene urea with polyacids and polyols used to form the polyester. Also, polyester prepolymers can be reacted with primary amines, aminoalkyl ethylene urea, or hydroxyalkyl ethylene urea to yield a material with pendant urea groups.

The polyester polymers typically have number average molecular weights of about 3,000 to 35,000 or 5,000 to 10,000 based on gel permeation chromatography using a polystyrene standard. The polyester polymers will have equivalent weights (based on the functional groups mentioned above) from 200 to 2,500 gram/equivalent or from 1,400 to 1,900 gram/equivalent. The T(g) of the polymer is typically about 25° C. to 85° C. or 50° C. to 70° C.

The powder coating composition of the invention also comprises a curing agent having functional groups reactive with the functional groups of the polymer. The curing agent must have functional groups that are reactive with the functional groups of the above mentioned polymer, and the curing agent must be present in an amount sufficient to cure the powder coating composition of the invention. Suitable curing agents include polyepoxides, beta-hydroxyalkylamides, triglycidylisocyanurate, and polyacids.

Polyepoxides as curing agents for carboxylic acid group-containing polymers are well known in the art. Examples of polyepoxides suitable for use as curing agents in the powder coating compositions of the present invention are those described in U.S. Pat. No. 4,681,811 at column 5, lines 33 to 58, incorporated herein by reference.

Beta-hydroxyalkylamides as curing agents for carboxylic acid group-containing polymers are well known in the art. Examples of beta-hydroxyalkylamides suitable for use as curing agents in the powder coating compositions of the invention are those described in U.S. Pat. No. 4,801,680 at column 2, line 42 to column 3, line 9, incorporated herein by reference.

Triglycidylisocyanurate (TGIC), a weatherable epoxy crosslinker commercially available as ARALDITE TM PT-810 from Ciba-Geigy, is well known in the art as a useful curing agent for carboxylic acid group-containing polymers.

Polyacids, particularly polycarboxylic acids, are well known in the art as curing agents for epoxy functional group-containing acrylic polymers. Examples of suitable polycarboxylic acids and polycarboxylic acid group-containing polyesters curing agents are those described in U.S. Pat. No. 5,407,707 at column 3, line 55 to column 4, line 10, incorporated herein by reference.

Aminoplast and phenoplast curing agents are suitable curing agents for polymers having hydroxyl, carboxylic acid, carbamate and urea functional groups. Examples of suitable aminoplast include alkylated methylol melamine and alkylated methylol urea.

Polyisocyanurate and blocked polyisocyanates are suitable curing agents for polymers having hydroxyl and amino groups. Examples of suitable blocked polyisocyanates include benzene triisocyanate, uretidione of isophorone diisocyanate (IPDI), the butanol version of IPDI, and the caprolactam version of IPDI. The butanol version of IPDI and the caprolactam version of IPDI are commercially available from Creanova, Inc. as Vestogon BF 1530 and Vestogon EB 1400.

The polyisocyanate can be a diisocyanate. Suitable aliphatic diisocyanates include 1,4-tetramethylene diisocyanate and 1,6-hexamethylene diisocyanate. Examples of suitable aromatic diisocyanates include 4,4′-diphenylmethane diisocyanate, 1,3-phenylene diisocyanate, 1,4-phenylene diisocyanate, and toluene diisocyanateo. Examples of suitable cycloaliphatic diisocyanates include 1,4-cyclohexyl diisocyanate, isophorone diisocyanate, and 4,4′-methylene-bis(cyclohexyl isocyanate).

Typically, the curing agent is present in the powder coating composition of the invention in an amount ranging from 2 to 50 weight percent or from 5 to 20 weight percent, said weight percentages based on the total weight of resin solids in the powder coating composition.

The powder coating composition of the present invention also comprises a phenolic compound having substituted groups on the two groups adjacent to the hydroxy group on the aromatic ring (which is generally either the 2 and 6 positions or the 3 and 5 positions). The substituted groups can be alkyl or branched alkyl groups. The alkyl groups can contain from 1 to 18 carbon atoms. The preferred substituted groups are tertiary butyl. An exemplary phenolic compound is 2,6 di-tert-butyl-4-methyl-phenol.

The powder coating composition of the present invention can also include the following materials which are all well known in the art: pigments, fillers, light stabilizers, anti-oxidants, flow control agents, anti-popping agents, and catalyst.

To form the powder coating composition of the present invention, the above mentioned components must be melt blended. Melt blending can be accomplished via the following steps. First, all of the components are blended in a high shear mixer such as a Henschel Blender. Second, the blended components are melt blended in an extruder at a temperature between 80° C. and 130° C. Third, the extrudate is cooled. Finally, the cooled extrudate is pulverized into a particulate blend. The material is ground to a particle size of 15 to 150 microns or 35 to 55 microns using a grinding mill such as the Air Classifying Mill (ACM II) commercially available from Micron Powder Systems in Summit, N.J.

The powder coating composition of the present invention can be applied directly to a substrate such as wood, plastic, steel and aluminum. The finished powders can be electrostatically sprayed onto test panels and evaluated for coating properties.

### EXAMPLES

The present invention will now be illustrated by the following specific, non-limiting examples. The preparation of Examples 1-8 is described below. Each coating composition contains some basic ingredients plus an additive. Table 1 lists the additive used in each composition. Table 2 contains information about the performance of the exemplary compositions in regard to filiform performance.

### PREPARATION OF THE EXAMPLES

Examples 1-8 were made using the same basic ingredients plus an additive. The basic ingredients are as follows:

399.5 g of an acid functional polyester commercially available from UCB Chemicals as Crylcoat 630;

151.7 g of an acrylic co-polymer developed by PPG Industries, Inc. based on 40% glycidyl methacrylate and 60% isobornyl methacrylate;

10.0 g of b-hydroxy-alkylamide commercially available as PRIMID® from EMS-CHEMIE AG;

4.8 g of a fatty acid amide (bisstearamide of ethylene diamine) commercially available from Hoechst Celanese as Wax C MicroPowder;

1.9 g of Benzoin commercially available from Monsanto Chemical Company as Uraflow B;

9.6 g of silicone/amide flow control additive available from Troy Chemical Corp. as Troy 570;

6.4 g of an ultraviolet light absorber which chemically is 2 tertiary-butyl-2-(4-hydroxy-3, 5-di-tertiary-butylbenzyl) [bis(methy12,26,6-tetramthyl-4-piperinyl) dipropionate commercially available from Ciba-Geigy Corp. as Tinuvin 144;

12.8 g of a triazine which is commercially available from Ciba Specialty Chemicals as CGL 15A5;

6.4 g of stearic acid; and

26.2 g of a mixture comprising 1 mole of pentaerythritol which is heated with approximately six moles of dodecanedioic acid.

In addition to the above ingredients, each Example contained 19.3 grams of a different additive. The additive included in each Example is shown in the Table 1 below.

TABLE 1
ADDITIVE COMPOSITIONS

| Example | Additive |
|---|---|
| 1 | 2,6 di-tert-butyl-4-methyl-phenol |
| | (commercially available as lonol from |
| | Aldrich Chemical Co.) |
| 2 | 2,5 di-tert-butyl-4-methoxy-phenol |
| 3 | 3,5 di-tert-butyl-phenol |
| 4 | tetrakis [3-(3,5-di-tertiary-butyl-4 |
| | hydroxyphenyl) propionyloxymethyl] |
| | methane (commercially available as |
| | Irganox 1010 from Ciba Specialty |
| | Chemicals) |
| 5 | n-octadecyl 3-(3,5-di-tertiary-butyl-4 |
| | hydroxyphenyl) propionate |
| | (commercially available as Irganox 1076 |
| | from Ciba Specialty Chemicals) |
| 6 | 2,6-dibromo-phenol |
| 7 | No additive |
| 8 | Envirocryl PCC 10103 commercially |
| | available from PPG Industries, Inc. |

Examples 1-8 were prepared via hot melt mixing in a conventional extruder; the operation of which is well known to those skilled in the art. The variables of the extruder were set as follows:

Feed=30 RPM:

Extruder temperature=80° C. to 150° C.; and

Speed=100 to 700 RPM with aggressive mixing conditions.

Table 2 shows the filiform performance of Examples 1-8 above.

TABLE 2
FILIFORM PERFORMANCE

| | | | | Filament |
|---|---|---|---|---|
| | Average Length | Density¹ | Longest Length | Width |
| Example | (mm) | (per cm) | (mm) | (mm) |
| 1 | 2.0 | 2.0 | 3.0 | 0.5 |
| 2 | 1.0 | 3.0 | 2.0 | 0.3 |
| 3 | 1.0 | 1.0 | 3.0 | 2.0 |
| 4 | 0.5 | 7.0 | 3.0 | 0.3 |
| 5 | 2.0 | 5.0 | 3.0 | 0.5 |
| 6 | 2.0 | 4.0 | 2.0 | 0.5 |
| 7 | 5.0 | 2.0 | 8.0 | 0.5 |
| 8 | 9.0 | 8.0 | 13.0 | 1.0 |

¹Density is the number of tiny visible filaments on a wheel per centimeter.

### CONCLUSION

As can be seen from the results compiled in Table 2, the filiform resistance properties of phenolic compounds can be improved by adding certain substituent groups adjacent to an aromatic phenol. In general, aromatic phenols with α, α′ substituents that can be formulated into a solid powder exhibit improved filiform resistance properties

What is claimed:

1. A curable powder coating composition comprising:
a. a polymer containing reactive functional groups;
b. a curing agent having functional groups reactive with the functional groups of the polymer which is present in an amount sufficient to cure the polymer; and
c. a phenolic compound having substituted groups on the two groups adjacent to the hydroxy group on the aromatic ring.

2. The powder coating composition of claim 1 wherein the substituted groups are alkyl groups or branched alkyl groups.

3. The powder coating composition of claim 2 wherein the alkyl group contains from 1 to 18 carbon atoms.

4. The powder coating composition of claim 1 wherein said phenolic compound is 2,6 ditert-butyl-4-methyl-phenol.

5. The powder coating composition of claim 1 wherein said polymer containing reactive functional groups is selected from the group consisting of acrylic polymers, polyester polymers, and polyurethane polymers.

6. The powder coating composition of claim 1 wherein said polymer has a number average molecular weight of from 1,000 to 20,000.

7. The powder coating composition of claim 1 wherein said polymer has an equivalent weight equal from 200 to 2,500.

8. The powder coating composition of claim 1 wherein said reactive functional groups are carboxylic acid groups and the curing agent is a beta-hydroxyalkylamide.

9. The powder coating composition of claim 8 wherein the beta-hydroxyalkylamide is bis-hydroxyethylamide.

10. The powder coating composition of claim 1 wherein said reactive functional groups are carboxylic acid groups and the curing agent is a polyepoxide.

11. The powder coating composition of claim 10 wherein said curing agent is triglycidylisocyanurate.

12. The powder coating composition of claim 1 wherein said phenolic compound is present in an amount ranging from 0.5 to 10 weight percent based on the total weight resin solids in the powder coating composition.

13. The powder coating composition of claim 1 wherein said polymer is present in an amount ranging from 10 to 80 weight percent based on the total weight resin solids in the powder coating composition.

14. The powder coating composition of claim 1 wherein said curing is present in an amount ranging from 2 to 40 weight percent based on the total weight resin solids in the powder coating composition.

15. The powder coating composition of claim 1 where said polymer is an acrylic polymer containing carboxylic acid functionality.

16. A curable powder coating composition comprising:
a. an acrylic polymer containing carboxylic acid functional groups;
b. a beta-hydroxyalkylamide curing agent; and
c. 2,6 di-tert-butyl-4-methyl-phenol.

17. A curable powder coating composition comprising:
a. from 5 to 60 weight percent of an acrylic polymer containing carboxylic acid functional groups;
b. from 0.5 to 10 percent by weight of a beta-hydroxyalkylamide curing agent and
c. from 2 to 40 weight percent of 2,6 di-tert-butyl-4-methyl-phenol, wherein the percent by weight is based on total resin solids weight of the powder coating composition

18. A coated aluminum substrate containing a cured coating comprising:
a. a polymer containing reactive functional groups;
b. a curing agent having functional groups reactive with the functional groups of the polymer which is present in an amount sufficient to cure the polymer; and
c. a phenolic compound having substituted groups on the two groups adjacent to the hydroxy group on the aromatic ring.
